(19) United States
(12) Patent Application Publication
(10) Pub. No.: US 2007/0005556 A1
(43) Pub. Date: Jan. 4, 2007

(54) Probabilistic techniques for detecting duplicate tuples

(75) Inventors: Venkatesh Ganti, Redmond, WA (US); Ying Xu, Stanford, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/172,578

(22) Filed: Jun. 30, 2005

(51) Int. Cl. G06F 17/30

(52) U.S. Cl. 707/1

(57) ABSTRACT

A technique for probabilistic determining fuzzy duplicates includes converting a plurality of tuples into hash vectors utilizing a locality sensitive hashing algorithm. The hash vectors are sorted, on one or more vector coordinates, to cluster similar hash coordinate values together. Each cluster of two or more hash vectors identifies candidate tuples. The candidate tuples are compared utilizing a similarity function. Tuples which are more similar than a specified threshold are returned.

### BACKGROUND

As computational power and performance continue to increase more and more enterprises are storing data in databases for use in their business. Furthermore, enterprises are also collecting ever increasing amounts of data. The data is stored as records, tables, tuples and other grouping of related data, herein after referred collective to as tuples. The data is stored queried, retrieved, organized filtered, formatted and the like by evermore powerful database management systems to generate vast amounts of information. The extent of the information is only limited by the amount of data collected and stored in the database.

Unfortunately, multiple seemingly distinct tuples representing the same entity are regularly generated and stored in the database. In particular, integration of distributed, heterogeneous databases can introduce imprecision in data due to semantic and structural inconsistencies across independently developed databases. For example, spelling mistakes, inconsistent conventions, missing attribute values, and the like often cause the same entity to be represented by multiple tuples.

The duplicate tuples reduce the storage space available, may slow the processing speed of the database management system, and may result in less then optimal query results. In the conventional art, fuzzy duplicate tuples may be identified whose similarity is greater than a user-specified threshold utilizing a conventional similarity function. One method includes exhaustive apply the similarity function to all pairs of tuples. In another method, a specialized indexes (e.g., if available for the chosen similarity function) may be utilized to identify candidate tuple pairs. However, the index-based approaches result in a large number of random accesses while the exhaustive search performs a substantial number of tuple comparisons.

### SUMMARY

The techniques described herein are directed toward probabilistic algorithms for detecting fuzzy duplicates of tuples. Candidate tuples are grouped together through a limited number of scans and sorts of the base relation utilizing locality sensitivity hash vectors. A similarity function is applied to determine if the candidate tuples are fuzzy duplicates. In particular, each tuple is converted into a vector of hash values utilizing a locality sensitive hash (LSH) function. All of the hash vectors are sorted on one or more select hash coordinates, such that tuples that share the same hash value for a given vector coordinate will cluster together. Tuples that cluster together for a given vector coordinate are identified as candidate tuples, such that probability of not detecting a fuzzy duplicate is bounded. The candidate tuples are compared utilizing a similarity function. The tuple pairs that are more similar than a predetermined threshold are returned.

### BRIEF DESCRIPTION OF THE DRAWINGS

Embodiments are illustrated by way of example and not by way of limitation, in the figures of the accompanying drawings and in which like reference numerals refer to similar elements and in which:

FIG. 1 shows a block diagram of a system for detecting fuzzy duplicates.

FIG. 2 shows a flow diagram of a method for detecting fuzzy duplicate tuples.

FIG. 3 shows a block diagram of an exemplary set of tuples.

FIG. 4 shows a block diagram of exemplary hash vectors.

FIG. 5 shows a flow diagram of a smallest bucket (SB) instantiation of detecting fuzzy duplicate tuples.

FIG. 6 shows a flow diagram of a multi-grouping hash function instantiation of detecting fuzzy duplicate tuples.

FIG. 7 shows a flow diagram of a smallest bucket dynamic grouping (SBDG) instantiation of detecting pairs of fuzzy duplicate tuples.

### DETAILED DESCRIPTION OF THE INVENTION

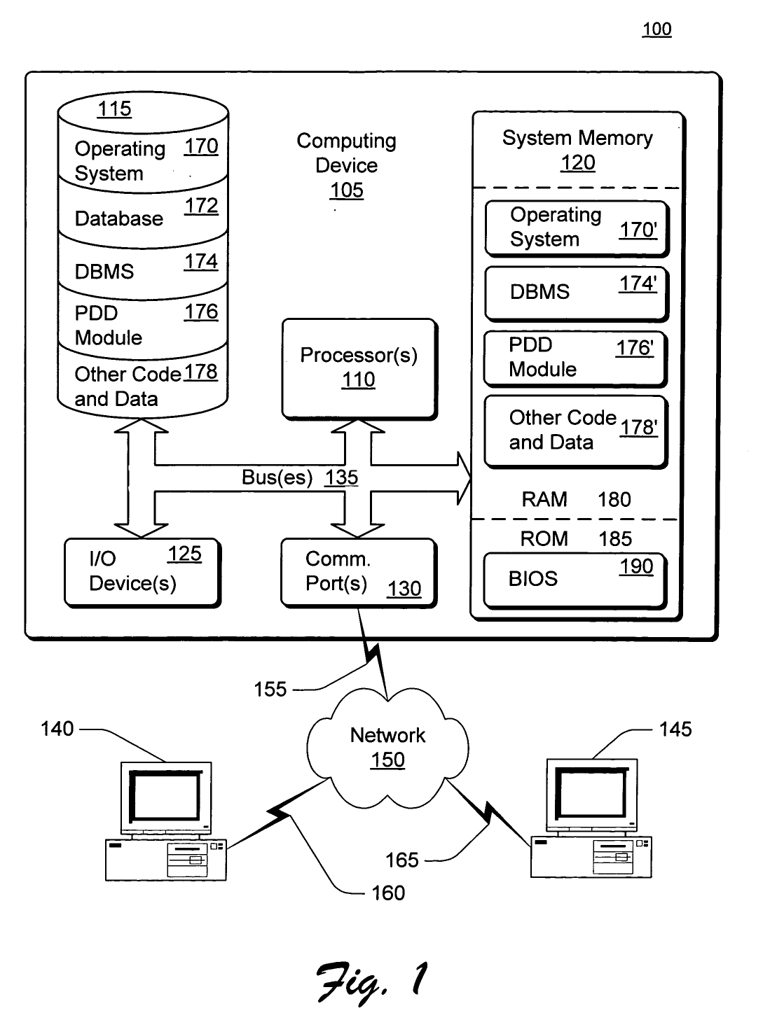

FIG. 1 shows a system 100 for detecting fuzzy duplicates. The system 100 may be implemented on a computing device 105, such as a personal computer, server computer, client computer, hand-held or laptop device, minicomputer, mainframe computer, distributed computer system, or the like. The computing device 105 may include one or more processors 110, one or more computer-readable media 115, 120 and one or more input/output devices 125, 130. The computer-readable media 115, 120 and input/output devices 125, 130 may be communicatively coupled to the one or more processors 110 by one or more buses 135. The one or more buses 135 may be implemented using any kind of bus architectures or combination of bus architectures, including a system bus, a memory bus or memory controller, a peripheral bus, an accelerated graphics port and/or the like. It is appreciated that the one or more buses 135 provide for the transmission of computer-readable instructions, data structures, program modules, code segments and other data encoded in one or more modulated carrier waves. Accordingly, the one or more buses 135 may also be characterized as computer-readable media.

The input/output devices 125, 130 may include one or more communication ports 130 for communicatively coupling the computing device 105 to one or more other computing devices 140, 145. The one or more other devices 140, 145 may be directly coupled to one or more of the communication ports 130 of the computing device 105. In addition, the one or more other devices 140, 145 may be indirectly coupled through a network 150 to one or more of the communication ports 130 of the computing device 105. The networks 150 may include an intranet, an extranet, the Internet, a wide-area network (WAN), a local area network (LAN), and/or the like.

The communication ports 130 of the computing device 105 may include any type of interface, such as a network adapter, modem, radio transceiver, or the like. The communication ports 130 may implement any connectivity strategies, such as broadband connectivity, modem connectivity, digital subscriber link (DSL) connectivity, wireless connectivity or the like. It is appreciated that the communication ports 130 and the communication channels 155-165 that couple the computing devices 105, 140, 145 provide for the transmission of computer-readable instructions, data structures, program modules, code segments, and other data encoded in one or more modulated carrier waves (e.g., communication signals) over one or more communication channels 155-165. Accordingly, the one or more communication ports 130 and/or communication channels 155-165 may also be characterized as computer-readable media.

The computing device 105 may also include additional input/output devices 125 such as one or more display devices, keyboards, and pointing devices (e.g., a “mouse”). The input/output devices 125 may further include one or more speakers, microphones, printers, joysticks, game pads, satellite dishes, scanners, card reading devices, digital cameras, video cameras or the like. The input/output devices 125 may be coupled to the bus 135 through any kind of input/output interface and bus structures, such as a parallel port, serial port, game port, universal serial bus (USB) port, video adapter or the like.

The computer-readable media 115, 120 may include system memory 120 and one or more mass storage devices 115. The mass storage devices 115 may include a variety of types of volatile and non-volatile media, each of which can be removable or non-removable. For example, the mass storage devices 115 may include a hard disk drive for reading from and writing to non-removable, non-volatile magnetic media. The one or more mass storage devices 115 may also include a magnetic disk drive for reading from and writing to a removable, non-volatile magnetic disk (e.g., a “floppy disk”), and/or an optical disk drive for reading from and/or writing to a removable, non-volatile optical disk such as a compact disk (CD), digital versatile disk (DVD), or other optical media. The mass storage devices 115 may further include other types of computer-readable media, such as magnetic cassettes or other magnetic storage devices, flash memory cards, electrically erasable programmable read-only memory (EEPROM), or the like. Generally, the mass storage devices 115 provide for non-volatile storage of computer-readable instructions, data structures, program modules, code segments, and other data for use by the computing device. For instance, the mass storage device may store an operating system 170, a database 172, a database management system (DBMS) 174, a probabilistic duplicate tuple determination module 176, and other code and data 178.

The system memory 120 may include both volatile and non-volatile media, such as random access memory (RAM) 180, and read only memory (ROM) 185. The ROM 185 typically includes a basic input/output system (BIOS) 190 that contains routines that help to transfer information between elements within the computing device 105, such as during startup. The BIOS 190 instructions executed by the processor 110, for instance, causes the operating system 170 to be loaded from a mass storage device 115 into the RAM 180. The BIOS 190 then causes the processor 110 to begin executing the operating system 170′ from the RAM 180. The database management system 174 and the probabilistic duplicate tuple determination module 176 may then be loaded into the RAM 180 under control of the operating system 170′.

The probabilistic duplicate tuple determination module 176′ is configured as a client of the database management system 174′. The database management system 174′ controls the organization, storage, retrieval, security and integrity of data in the database 172. The probabilistic duplicate tuple determination module 176′ converts each tuple to a vector of hash values utilizing a locality sensitive hashing algorithm. The hash vectors are sorted, on one or more vector coordinates, to cluster similar hash values (e.g., tuples) together. Each cluster of similar hash values identify candidate tuples The module 176′ probabilistically detects candidate fuzzy duplicate tuples by selecting a set of vector coordinates to sort upon. The module compares the candidate fuzzy duplicate tuples utilizing a similarity function and returns pairs of tuples which are more similar than a specified threshold.

In one implementation, the number of vector coordinates to sort upon is selected as a function of a specified threshold of similarity and a specified error probability of not detecting a fuzzy duplicate. In another implementation, the probabilistic duplicate determination module 176′ selectively chooses buckets to determine which tuples to compare. The buckets are chosen as a function of the frequency of the hash coordinate values of a particular hash value. In another implementation, the module 176′ groups multiple hash coordinates together. The vectors are sorted based upon one or more of the groups of hash coordinates. In yet another implementation, the module groups multiple hash coordinates together and chooses one or more groups to sort upon based upon the collective frequency of hash coordinate values in the groups of hash coordinates.

Although for purposes of illustration, the database 172, database management system 174 and probabilistic duplicate detection module 176 are shown implemented on a single computing device 105, it is appreciated that the system may be implemented in a distributed computing environment. For example, the database 172 may be stored on a data store 140, and the probabilistic duplicate detection module 176 may be executed on a client computing device 145. The database management system 174 may be implemented on a server computing device 105 communicatively coupled between the data store 140 and the client computing device 145.

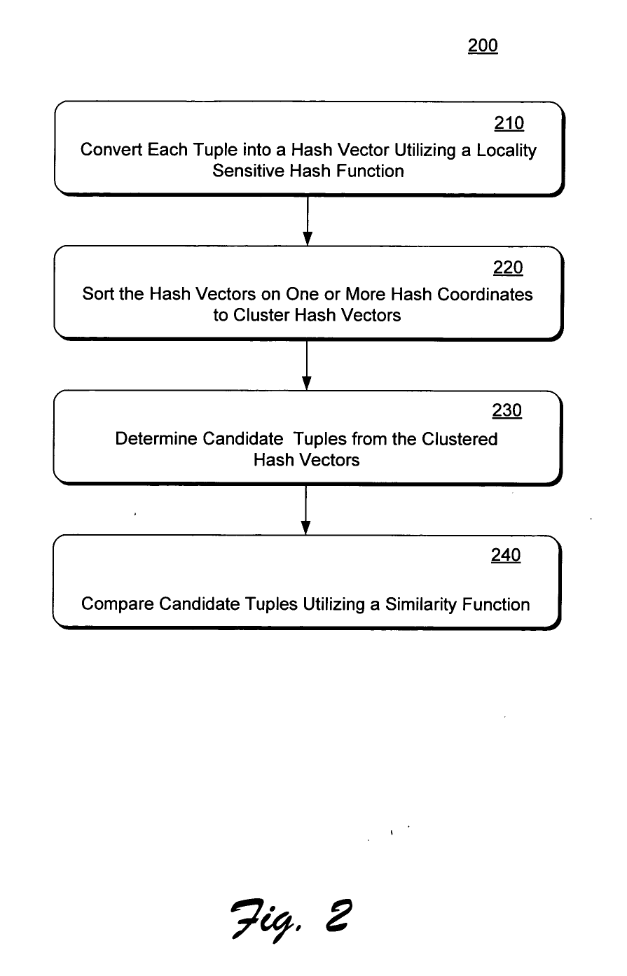

FIG. 2 shows a method for detecting fuzzy duplicate tuples. The method includes converting each tuple into a vector of hash values utilizing a locality sensitive hash (LSH) function, at 210. Each field, token or the like of a tuple is hashed to generate a corresponding hash coordinate value of the hash vector. All of the hash vectors are sorted on one or more coordinates, at 220. Tuples that share the same hash value for a given vector coordinate will cluster together during sorting. At 230, tuples that share the same hash value for a given vector coordinate are identified as candidate tuples. At 240, the candidate tuples are compared utilizing a similarity function. The tuple pairs that are more similar than a predetermined threshold (e.g., fuzzy duplicates) are returned. The fuzzy duplicates may be determined according to several similarity functions, such as Jaccard similarity and some of its variants, cosine similarity, edit distance, and the like.

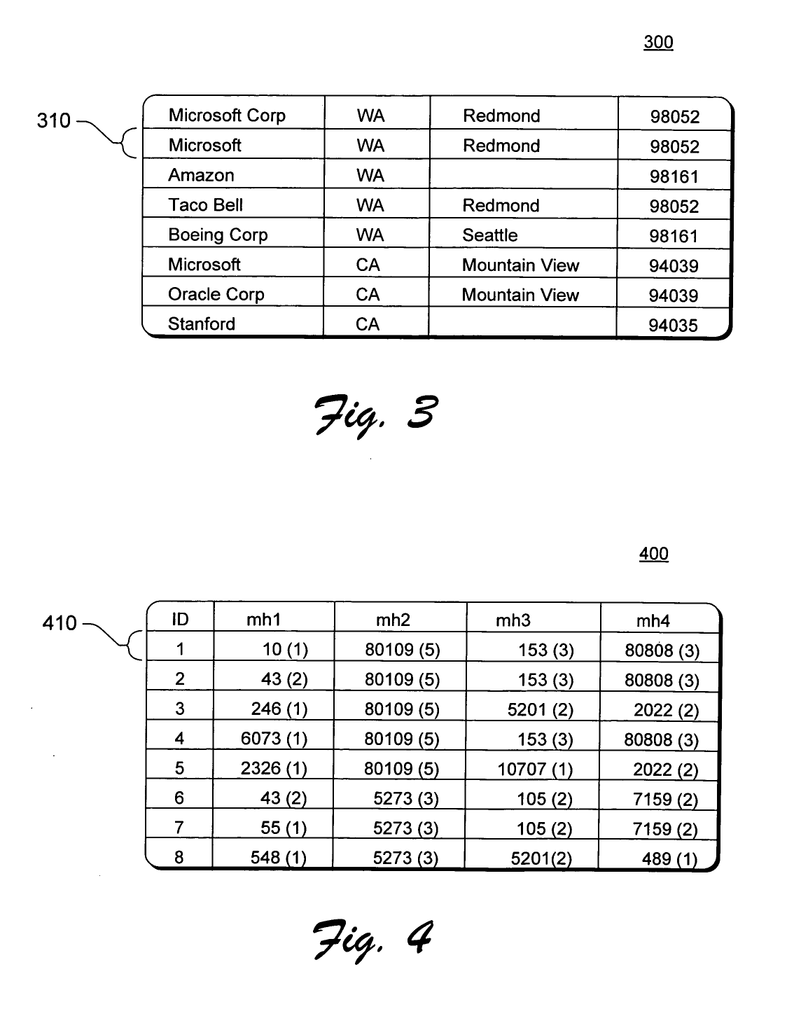

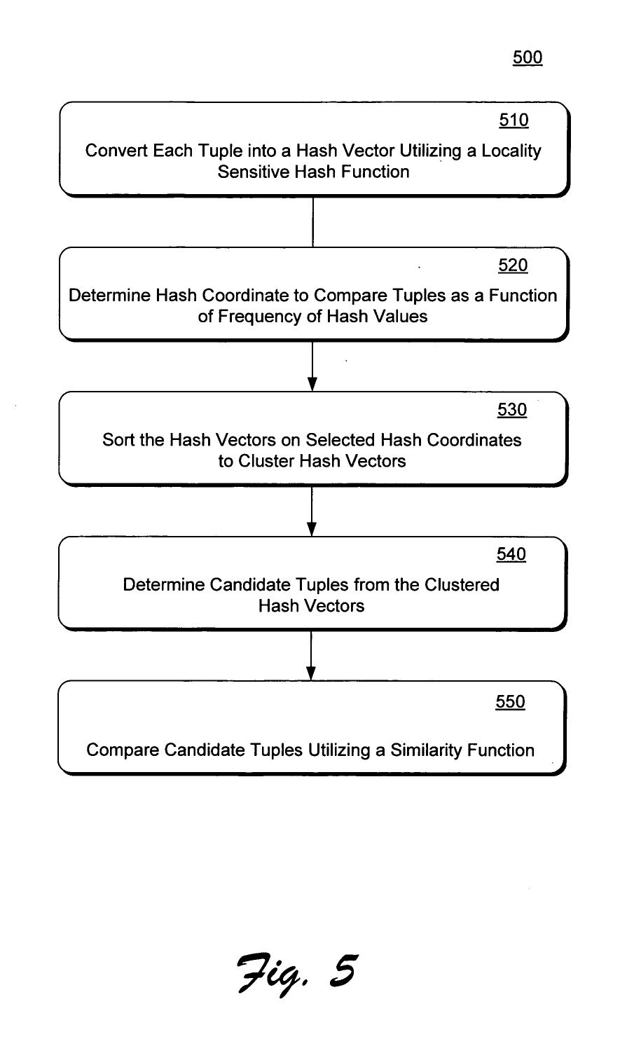

In one implementation, fuzzy duplicates may be determined utilizing a min-hash function and the Jaccard Similarity Function. Referring to FIG. 3 an exemplary set 300 of tuples 310 is shown. A min-hash vector:
MinHash(R)=[ID, mh₁, mh₂, . . . , mhₕ]
is generated for each tuple. A locality sensitive hashing scheme with respect to similarity function f is a distribution on a family H of hash functions on a collection of objects, such that for two objects x and y, Pr_{hεH}[h(x)=h(y)]=f(x,y). One instance of the locality sensitive hashing scheme is the min-hash function. The min-hash function h maps elements U uniformly and randomly to the set of natural numbers N, wherein U denotes the universe of strings over an alphabet Σ. The min-hash of a set S, with respect to h, is the element x in S minimizing h(x) such that mh(S)=arg min_{xεs}h(x). A min-hash vector of S with identifier ID is a vector of H min-hashes (ID, mh₁, mh₂, . . . mh_{H}), where mhᵢ=arg min_{xεs}hᵢ(x) and h₁, h₂, . . . , h_{H} are H independent random functions. FIG. 4 shows exemplary hash vectors 400 corresponding to the set of tuples 300 shown in FIG. 3. The frequency of each hash value is noted in parenthesis adjacent each hash coordinate.

Sorting MinHash(R) on each of the min-hash coordinates mhᵢ clusters together tuples that are potentially close to each other. The pairs of tuples which are in the same cluster are compared using a similarity function. A cluster of tuples by a given hash coordinate is referred herein to as a bucket. More specifically, a bucket B(i,c), specified by an index i and a hash value c, is the set of all min-hash vectors that have value c on mhᵢ. The size of the bucket is the number of hash vectors (e.g., tuples) in the bucket. For example, sorting on the first coordinate mh1 yields seven buckets, with tuples 2 and 6 sharing the same hash value. Thus, sorting on the first hash coordinate mh1 generates one candidate pair (2,6) Sorting on the second hash coordinate mh2 generates thirteen candidate pairs from the bucket containing five tuples and the other bucket containing three tuples. Sorting on the third coordinate mh3 generates five candidate tuple pairs. Sorting on the fourth coordinate mh4 also generates five candidate tuple pairs.

The number of tuple comparisons is proportional to the sum of squares of the frequency of each of the distinct hash values. Only pairs of tuples that fall into the same bucket are compared, which significantly reduces the number of similarity function tuple comparisons. Besides the reduction of comparisons, sorting on min-hash coordinates results in natural clustering and avoids random accesses to the base relation. Candidate tuples may be identified such that the probability with which any pair of tuples in the input relation whose similarity is above a specified threshold is bounded by a specified value. The probabilistic approach allows reduction in the number of sorts of the min-hash vectors and the base relation and the number of candidate tuples compared. In particular, probabilistic fuzzy duplicate detection for any candidate tuple pair (u, v), such that the similarity function f(u, v) is greater than a threshold θ, returns the tuple pair (u, v) with probability of at least 1−ε. Wherein the error bound ε is the probability with which one may miss tuple pairs whose similarity is above θ. The number of hash vector coordinates h needed to identify candidate tuple pairs is determined by the error bound ε and the threshold θ as follows:
h=ln(ε)/ln(1−θ)
For example, with threshold θ=0.9, ε=0.01, h=2 min-hash coordinates are required.

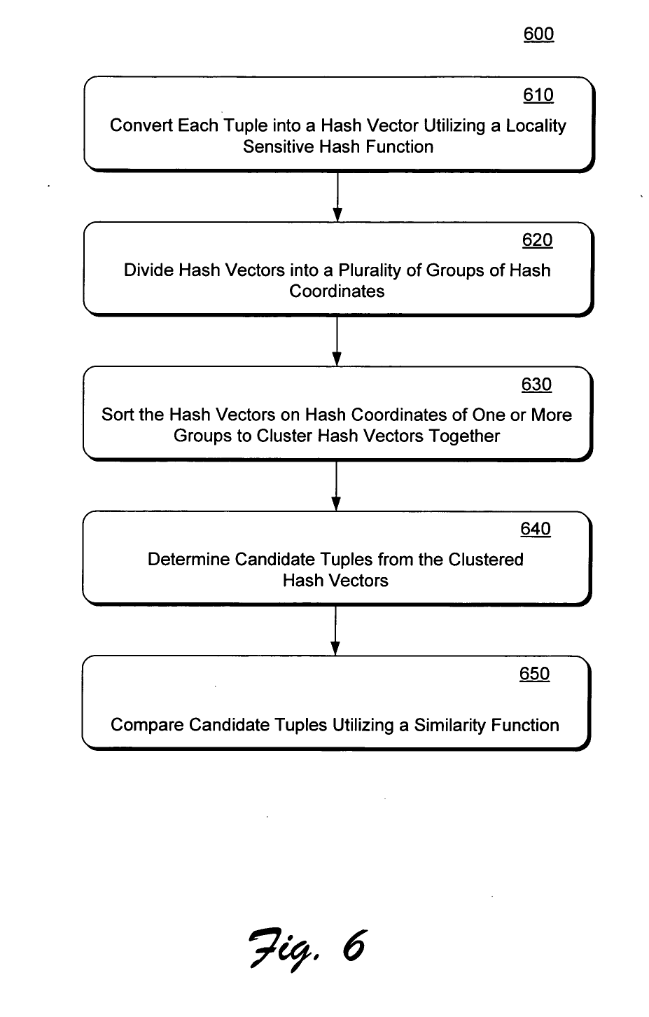

The choices underlying when to compare two tuples lead to several instances of probabilistic algorithms for detecting pairs of fuzzy duplicates. Referring now to FIG. 5, a smallest bucket (SB) instantiation of detecting fuzzy duplicate tuples is shown. The method includes converting each tuple into a vector of hash values utilizing a locality sensitive hash (LSH) function, at 510. Each field, token or the like of a tuple is hashed to generate a corresponding hash coordinate value of the hash vector. In one implementation, the locality sensitive hashing function is a min-hash algorithm.

Hash vector coordinates are selected for each tuple such that the total number of selected tuple pairs to be compared is minimized. In particular, one or more hash coordinates (k) for a particular hash vector are selected as a function of the frequency of hash values of the vector, at 520. More specifically, the frequencies of hash values are determined for each coordinate of a particular hash vector. The k selected coordinates for the particular vector are coordinates that have smaller frequencies (e.g., smallest bucket), as compared to the vector coordinate having the highest frequency. It is appreciated that vector coordinates having frequencies of one are not selected because they indicate that there is no potential duplicate tuple.

The tuples are compared based upon the selected vector coordinates. For each coordinate i, of a particular hash vector, the hash vectors are sorted to group tuples together, at 530. At 540, a tuple whose ith coordinate is selected is compared with tuples that share the same hash value as the selected hash vector coordinate; this procedure identifies candidate tuples. The candidate tuple are compared utilizing a similarity function, at 550. The pairs of tuples that are more similar than a predetermined threshold are returned. In one implementation, the similarity function may be a Jaccard similarity function, some variant of the Jaccard similarity function, a cosine similarity function, an edit distance similarity function or the like.

Accordingly, the smallest bucket algorithm exploits the variance in sizes of buckets (e.g., lower frequency for a given coordinate), over each of its hash coordinates, to which a tuple belongs. The higher the variance, the high the reduction in the number of tuple comparisons. However, the reduction in comparisons has to be traded off with the increased cost of materializing and sorting due to additional min-hash coordinates.

The choice of parameters can significantly influence the running times of various algorithms described above. In particular, let T_{B} denote the time to build min-hash relations. T_{B} is linearly proportional to H, the total number of min-hash coordinates per tuple. Let T_{B}=T₁+H·C_{B} for positive constants T₁ denoting the initialization overhead and C_{B} denoting the average cost for materializing each additional min-hash coordinate. Let T_{C} denote the time to evaluate the similarity function over all candidate pairs. T_{C}=N_{C}·C_{C} where N_{C} is the number of candidate pairs and C_{C} is the average cost of evaluating the similarity function once. Let T_{Q} denote the time to order the base relation. The cost here is equal to the number of times the relation is sorted times the average cost for sorting it once. (T_{Q} can include where necessary the cost for joining with MinHash(R) and the temporary relation with the coordinate selection information.) Let T_{Q}=T₂+q·C_{Q}, where q is the number of sort required by the algorithm, for appropriate positive constants T₂ and C_{Q}. Here, we assume that the average sorting cost is independent of the number of sort columns.

Given input data size and machine performance parameters, we can accurately estimate through test runs the constants C_{B}, C_{Q} and C_{C}. The relevant parameters for the smallest bucket (SB) algorithm are h, the number of min-hash coordinates, and k, the number of min-hash coordinates selected per tuple. The cost of the SB algorithm is approximately equal to T₁+T₂+h·C_{B}+h·C_{Q}+N_{C}·C_{C}. One estimates N_{C} given h and k and then choose values for h and k which minimize the overall cost. This is feasible because if the Jaccard similarity of (u,v) is greater than or equal to 0 then with probability at least 1−Σ(^{h}ⱼ)θj(1−θ)^{h-j} evaluated for j=0 to h-k, (u,v) is output by the smallest buckets algorithm. Accordingly, the value for h is constrained for a given k and vice-versa.

For the SB algorithm, the number of candidate pairs generated for any tuple u is bounded by the sum of sizes of the k smallest buckets selected corresponding to u. If one knows the distribution of the i^{th} smallest min-hash coordinate, 1≦i≦k, then we can estimate the total number N_{C} of candidate pairs. Towards this goal, we can rely on standard results from order statistics. Given the density distribution f(x) and the cumulative distribution F(x) of bucket sizes for any min-hash coordinate, we can estimate the density distribution f(X[i]) for the i^{th} smallest (of totally h) bucket size as follows:
F(X[i])=hf(x)(^{h-1}ᵢ₋₁)F(x)ⁱ⁻¹(1−Ff(x))^{h-1}

Using sampling-based methods to estimate the distribution f(x). The expected number of candidate pairs from one tuple is bounded by ΣE[X[i]] evaluate from i=1 to k, and the expected number of total candidates is estimated as n·ΣE[X[i]], where n is the number of tuples in the database. Using the values of N_{C}, C_{B}, C_{Q} and C_{C}, we determine the values of h and k which minimize the overall cost.

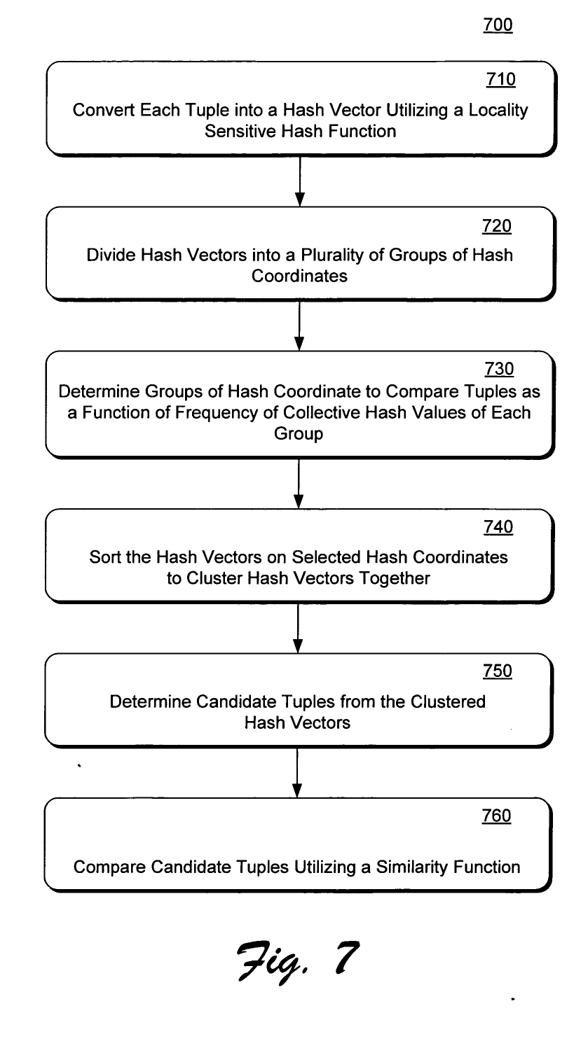

Referring now to FIG. 6, a multi-grouping hash function instantiation of detecting fuzzy duplicate tuples is shown. The method includes converting each tuple into a vector of hash values utilizing a locality sensitive hash (LSH) function, at 610. Each field, token or the like of a tuple is hashed to generate a corresponding hash coordinate value of the hash vector. In one implementation, the locality sensitive hashing function is a min-hash algorithm.

Hash vector coordinates are grouped such that the total number of candidate tuple pairs to be compared is reduced. In particular, the hash vectors are divided into groups of hash coordinates, at 620. The hash vectors are sorted based upon the selected group of vector coordinates, at 630. Hash vectors having the same hash values for each of the hash coordinates in the group will cluster together. At 640, candidate tuple pairs are determined from the clustered hash vectors. A tuple pair is a candidate if their hash values are equal for all the hash coordinates in the group. At, 650, the candidate tuple pairs are compared utilizing a similarity function. The pairs of tuples that are more similar than a predetermined threshold are returned. In one implementation, the similarity function may be a Jaccard similarity function, some variant of the Jaccard similarity function, a cosine similarity function, an edit distance similarity function or the like.

The relevant parameters for the multi-grouping algorithm are g, the size of each group of min-hash coordinates, and f, the number of groups. One can write the total running time for the MG algorithm as: T₁+T₂+f·g·C_{B}+f·C_{Q}+N_{C}·C_{C}. One can estimate N_{C} in terms of f and g and choose them such that the overall cost is minimized. This is feasible because the value for f is constrained in terms of g, and vice-versa. The values are constrained because the expected number of tuple comparisons performed by the MG algorithm is f·(ⁿ₂) E[Jaccard(u,v)^{g}]. If θ is the similarity threshold, then with probability at least 1−(1−θ^{g})^{f}, (u,v) is output by the MG algorithm.

Accordingly, the expectation of the number of total candidate pairs is bounded by f·(ⁿ₂) E[Jaccard(u,v)^{g}]. Using a random sample, we can estimate the expected value of the g^{th} moment of the Jaccard similarity between pairs of tuples. We then choose values for g and f which minimize the overall running time.

Referring now to FIG. 7, a smallest bucket with multi-grouping (SBMG) instantiation of detecting fuzzy duplicate tuples is shown. The method includes converting each tuple into a vector of hash values utilizing a locality sensitive hash (LSH) function, at 710. Each field, token or the like of a tuple is hashed to generate a corresponding hash coordinate value of the hash vector. In one implementation, the locality sensitive hashing function is a min-hash algorithm.

Groups of hash vector coordinates are selected such that the total number of candidate tuple pairs to be compared is minimized. In particular, the hash vectors are divided into K groups of hash coordinates, at 720. The groups of hash coordinates may be different for different hash vectors. At 730, the frequencies of the collective hash values are determined for each possible group of hash coordinates. Based upon these frequencies, the groups which minimize the total number of candidate tuples are finalized. The hash vectors are sorted based upon the collective hash values for each of the group of vector coordinates, at 750. Hash vectors having the same hash values for each of the hash coordinates in the select group of hash coordinates will cluster together. At 760, candidate tuple pairs are determined from the clustered hash vectors. A tuple pair is a candidate if their hash values are equal for all the hash coordinates in the group. At, 770, the candidate tuple pairs are compared utilizing a similarity function. The pairs of tuples that are more similar than a predetermined threshold are returned. In one implementation, the similarity function may be a Jaccard similarity function, some variant of the Jaccard similarity function, a cosine similarity function, an edit distance similarity function or the like.

In a smallest bucket with dynamic grouping (SBDM) instantiation, one or more hash coordinates for a particular hash vector are selected as a function of the frequency of hash values of the vector. In particular, the frequencies of hash values are determined for each coordinate of a particular hash vector. The k selected coordinates for the particular vector are coordinates that have smaller frequencies (e.g., smallest bucket), as compared to the vector coordinate having the highest frequency. It is appreciated that vector coordinates having frequencies of one are not selected because they indicate that there is no potential duplicate tuple. The vector coordinates not selected based upon smallest buck size may then be dynamically grouped with one or more of the selected coordinates. The hash vectors are sorted based upon the collective hash values for each of the group of vector coordinates. Hash vectors having the same hash values for each of the hash coordinates in the select group of hash coordinates will cluster together.

Generally, any of the processes for detecting duplicate tuples described above can be implemented using software, firmware, hardware, or any combination of these implementations. The term “logic, “module” or “functionality” as used herein generally represents software, firmware, hardware, or any combination thereof. For instance, in the case of a software implementation, the term “logic,” “module,” or “functionality” represents computer-executable program code that performs specified tasks when executed on a computing device or devices. The program code can be stored in one or more computer-readable media (e.g., computer memory). It is also appreciated that the illustrated separation of logic, modules and functionality into distinct units may reflect an actual physical grouping and allocation of such software, firmware and/or hardware, or can correspond to a conceptual allocation of different tasks performed by a single software program, firmware routine or hardware unit. The illustrated logic, modules and functionality can be located in a single computing device, or can be distributed over a plurality of computing devices.

Although probabilistic techniques for detecting fuzzy duplicate tuples have been described in language specific to structural features and/or methods, it is to be understood that the subject of the appended claims is not necessarily limited to the specific features or methods described. Rather, the specific features and methods are disclosed as exemplary implementations of techniques for detecting fuzzy duplicates of tuples.

What is claimed is:

1. A method of detecting fuzzy duplicates comprising:
converting each of a plurality of tuples into a hash vector of hash values utilizing a locality sensitive hash function;
sorting the plurality of hash vectors as a function of one or more hash coordinates;
identifying candidate tuples as a function of the sorted plurality of hash vectors; and
applying a similarity function to the candidate tuples.

2. A method of detecting fuzzy duplicates according to claim 1, wherein the locality sensitive hash function comprises a min-hash function.

3. A method of detecting fuzzy duplicates according to claim 1, wherein the similarity function is selected from a group consisting of a Jaccard similarity function, a cosine similarity function and an edit distance function.

4. A method of detecting fuzzy duplicates according to claim 1, wherein the number of the one or more hash coordinates are selected as a function of a specified threshold of similarity and a specified error probability of not detecting a fuzzy duplicate pair.

5. A method of detecting fuzzy duplicates according to claim 1, further comprising selecting the one or more hash coordinates to compare tuples as a function of a frequency of each hash coordinate value of a select hash vector.

6. A method of detecting fuzzy duplicates according to claim 1, further comprising:
dividing the hash vectors into a plurality of groups of hash coordinates; and
sorting the plurality of hash vectors as a function of one or more of the groups of hash coordinates.

7. A method of detecting fuzzy duplicates according to claim 1, further comprising:
dividing the hash vectors into a plurality of groups of hash coordinates;
selecting the one or more groups of hash coordinates to compare as a function of a frequency of a collective hash coordinate value for each of the plurality of groups; and
sorting the plurality of hash vectors as a function of one or more of the groups of hash coordinates.

8. One or more computer-readable media having instructions that, when executed on one or more processors, perform acts comprising:
converting each of a plurality of tuples into a hash vector;
sorting the plurality of hash vectors on one or more hash coordinate to cluster the hash;
determining candidate tuples from the clustered hash vectors; and
comparing candidate tuples utilizing a similarity function.

9. One or more computer-readable media according to claim 8, further comprising
selecting hash coordinates to compare on as a function of a frequency of hash values of each hash coordinate.

10. One or more computer-readable media according to claim 8, further comprising:
dividing the plurality of hash vectors into a plurality of groups of hash coordinates; and
sorting the plurality of hash vectors on one or more of the groups of hash coordinates.

11. One or more computer-readable media according to claim 8, further comprising:
dividing the plurality of hash vectors into a plurality of groups of hash coordinates;
selecting one or more groups of hash coordinates to compare on as a function of a frequency of collective hash values of each group of hash coordinates; and
sorting the plurality of hash vectors on the selected one or more groups of hash coordinates.

12. One or more computer-readable media according to claim 8, further comprising:
selecting hash coordinates as a function of a frequency of hash values of each hash coordinate;
forming groups of hash coordinates, wherein one or more unselected hash coordinates are grouped with one or more of the selected hash coordinates; and
sorting the plurality of hash vectors on one or more of the groups of hash coordinates;

13. One or more computer-readable media according to claim 8, wherein the tuples are converted to hash vectors using a min-hash function.

14. One or more computer-readable media according to claim 8, wherein the similarity function is selected from a group consisting of a Jaccard similarity function, a cosine similarity function and an edit distance function.

15. An apparatus comprising:
a processor; and
memory communicatively coupled to the processor;
wherein the apparatus is adapted to:
convert each of a plurality of tuples into a vector of hash values utilizing locality sensitive hash function;
sort the plurality of hash vectors as a function of one or more hash coordinates; and
apply a similarity function to a pair of tuples having the same hash values for the given hash coordinate.

16. An apparatus according to claim 15, wherein the locality sensitive hash function comprises a min-hash function.

17. An apparatus according to claim 15, wherein the similarity function is selected from a group consisting of a Jaccard similarity function, a cosine similarity function and an edit distance function.

18. An apparatus according to claim 15, wherein the one or more hash coordinates are selected as a function of a specified threshold of similarity and a specified error probability of not detecting a fuzzy duplicate pair.

19. An apparatus according to claim 15, wherein the one or more hash coordinates are selected as a function of a frequency of each of the hash coordinates of a particular hash vector.

20. An apparatus according to claim 15, wherein the one or more hash coordinates are selected from a plurality of groups of hash coordinates
